(19) United States
(12) Patent Application Publication
(10) Pub. No.: US 2004/0076752 A1
(43) Pub. Date: Apr. 22, 2004

(54) Method of painting, paint usable for the method, and method of producing the paint

(76) Inventors: R. Magdina, Kanianka (SK); B. Jacko, Prievidza (SK)

Correspondence Address: Ely Zborovsky Patent Bureau, 6 Schoolhouse Way, Dix Hills, NY, 11746, US

(21) Appl. No.: 10/650,664

(22) Filed: Aug. 29, 2003

Related U.S. Application Data
(63) Continuation-in-part of application No. 10/023,949, filed on Dec. 21, 2001, now Pat. No. 6,686,403.

(51) Int. Cl. B05D 5/00; C09D 5/16; C09D 5/18

(52) U.S. Cl. 427/256; 106/18.14; 106/18.15

(57) ABSTRACT

A method of painting surface, a paint usable in the painting method, and a method of producing a paint are provided, in which the paint includes a film-forming binder component for forming a film of the paint on the surface; a color-producing component for providing the predetermined color on the surface; and a fire-retardant component adapted to protect the surface from consequences of fire, such that when a surface is painted with the paint, the predetermined color is imparted to the surface and the surface is protected from fire.

### CROSS-REFERENCE TO A RELATED APPLICATION

The application is a continuation-in-part of patent application Ser. No. 10/023,949 filed on Dec. 21, 2001.

### BACKGROUND OF THE INVENTION

The present invention generally relates to methods of painting, paints, and methods of producing paints.

Objects are painted with paints in industry, household, and other areas of modern life. Known paints usually include a film-forming binder component which provides formation of a film and adhesion to a substrate on which the paint is to be applied, and also include a color-producing component, such as for example pigments and other coloring agents. Therefore when the surfaces are painted with existing paints, they obtain corresponding colors.

While the known paints provide a certain protection of surfaces on which they are applied from deleterious action of atmosphere and impart certain colors to the surfaces on which they are applied, they do not adequately protect the surfaces of the substrates from the consequences of a fire. It is believed to be advisable to eliminate this disadvantage.

### SUMMARY OF THE INVENTION

Accordingly, it is an object of the present invention to provide a method of painting, a paint and a method of producing a paint which avoid the disadvantages of the prior art.

In keeping with these objects and with others which will become apparent hereinafter, one feature of present invention resides, briefly stated, in a method of painting, comprising the steps of providing a paint including a film-forming binder component, a color-producing component, and a fire-retardant component; and painting a surface with said paint, so as to impart to the surface a corresponding color and also to substantially protect the surface from fire.

Another feature of the present invention resides in a paint which has a film-forming binder component; a color-producing component; and a fire-retardant component adapted to at least substantially protect from fire a surface of which the paint is applied.

Also, in accordance with a present invention a method for producing a paint is proposed, which has the steps of providing a film-forming binder component; providing a color-producing component; and adding a fire retardant component to produce a paint which after painting the surface, imparts a corresponding color to the surface and also substantially protects the surface from fire.

When the method of painting is performed, the paint is designed, and the method of producing the paint is implemented in accordance with the present invention, then in addition to conventional coloring of the surface by the paint, it also protects a surface of a substrate in which it is applied at least substantially from fire, and in many cases increases a corrosion resistance, and lengthens the service life of the paint.

In accordance with a further feature of the present invention the fire retardant component includes at least one phosphate or its derivative, such as melamine polyphosphate, ammonium polyphosphate.

In accordance with still a further feature of the present invention the fire retardant component includes melamine or is derivative selected from the group consisting of melamine cyanurate, melamine borate, melamine polyphosphate, melamine diphosphate, melamine pyrophosphate and melamine phosphate.

In accordance with still a further feature of the present invention, the fire-retardant component includes melamine, pentaerythritol, and melamine polyphosphate.

The novel features which are considered as characteristic for the present invention are set forth in particular in the appended claims. The invention itself, however, both as to its construction and its method of operation, together with additional objects and advantages thereof, will be best understood from the following description of specific embodiments.

### DESCRIPTION OF THE PREFERRED EMBODIMENTS

In accordance with the present invention a paint is provided which has a film-forming binder component, a color-producing component; and in addition has a fire-retardant component adapted to least substantially protect from fire a surface of which the paint is applied. When a surface is painted with such a paint, it not only colors the surface in a corresponding color, but also protects the surface from consequences of fire.

The fire retardant component can include phosphate or its derivative such as melamine polyphosphate, ammonium polyphosphate.

Also, the fire retardant component can include melamine or its derivative such as melamine cyanurate, melamine borate, melamine polyphosphate, melamine diphosphate, melamine pyrophosphate and melamine phosphate.

In the paint in accordance with the present invention the fire retardant component can include a charring agent, which is for example pentaerythritol, mono-pentaerythritol or di-pentaerythritol a blowing agent which for example is melamine, and an additional agent selected from the group of agents specified herein above.

It is to be understood that in addition to film generating substances (binding materials and softeners) which are one of the main components of paints which affect durability, shine, elasticity, bonding, flexibility and hardness, and also in addition to pigments which can be color powders not soluble in binders and soluble in color agents so as to create color variations and surface coloring capability the paint can also include volatile components which in combination with the binding materials create in most cases solution or so-called base lacquer (varnish). Also additives can be included in the paint, which are “helping” chemicals creating specific characteristics of the paints.

The paint in accordance with the present invention can be produced by a method which includes the steps of providing a film-forming binder component; providing a color-producing component, mixing said components with some of dried powder components missing; and adding a fire retardant component to replace the dry powder components.

In particular, fillers, such as for example calcium carbonate and titanium dioxide, are substituted by the fire retardant component. However, it is of course possible to substitute small amounts of film generating component.

In the paint in accordance with the present invention additional components are introduced, including a filler and an additive, as will be shown in the examples.

The fire-retardant component of the paint in accordance with the present invention can constitute not more than 15 weight % of the paint. This feature is very important, since as a result this fire-retardant component fully imparts fire-retardant properties to the paint, and at the same time does not detrimentally alter its composition, so that the major painting properties of the paint are fully retained.

In accordance with a further feature of the present invention the fire-retardant component includes melamine, pentaerythritol and melamine polyphospate. The ratio by weight of these ingredient of the fire-retardant component can be 35:35:30, and can include correspondingly 5.25, 5.25 and 4.50 weight % of total weight of the paint. The thusly formed fire-retardant component is very efficient, and its content in the paint can be maintained at the level not more than 15% of the total weight of the paint.

The inventive paint which is used in the inventive method of painting and produced by the method in accordance with the present invention is illustrated by the following examples:

### EXAMPLE 1

Epoxy Paint-Two Components

| | | |
|---|---|---|
| Function | Material | Weight % |

Part A

| | | | |
|---|---|---|---|
| Liquid Epoxy Resin | Epotuf 37-127 | 32.80 | Film Forming Binder |
| Diluent | Benzyl Alcohol | 3.75 | Film Forming Binder |
| Dispersant | BYK P-104S | 0.32 | Additives |
| Anti-Crater Additive | BYK A-530 | 0.15 | Additives |
| Flow Additive | BYK 501 | 0.16 | Additives |
| Prime Pigment | Titanox 2020 | 12.3 | Color Producing Component |
| Extender | Microna 7 | 18.99 | Dry Powder Component |
| Blowing Agent | Melamine | 5.25 | Fire Retardant Component |
| Catalyst | Melamine Polyphosphate | 4.50 | Fire Retardant Component |
| Carbonific | Pentaerythritol | 5.25 | Fire Retardant Component |

Part B

| | | | |
|---|---|---|---|
| Polyamine Hardener | Epotuf 37-801 | 13.32 | Film Forming Binder |
| Diluent | Benzyl Alcohol | 3.21 | Film Forming Binder |
| | | 100.00 | |

Mix Part A/Part B 4/1 by volume

### EXAMPLE 2

Alkyd Undercoat

| Function | Material | Weight % | |
|---|---|---|---|
| Medium Oil Aklyd 80% | Beckosol AA-203 | 31.48 | Film Forming Binder |
| Solvent | Mineral Spirits | 21.94 | Volatile Component |
| Dispersant | Soya Lecithin | 0.13 | Additives |
| Thixotrops | Thixatrol ST | 0.32 | Thixotrope |
| Sag Control | Post 4 | 0.44 | Thixotrope |
| Cobalt Drier | 12% Cobalt Naphthenate | 0.08 | Additives |
| Calcium Drier | 6% Calcium Naphtenate | 0.78 | Additives |
| Anti-Skin Agent | Methyl Ethyl Ketoxine | 0.33 | Additives |
| Prime Pigment | Tipure 902 | 21.40 | Color Producing Comp |
| Extender Pigment | Nicron 604 | 8.12 | Dry Powder Component |
| Blowing Agent | Melamine | 5.25 | Fire Retardant Component |
| Catalyst | Melamine Polyphosphate | 4.50 | Fire Retardant Component |
| Carbonific | Pentaerythritol | 5.25 | Fire Retardant Component |
| | | 100.00 | |

### EXAMPLE 3

Urethane Enamel

| Function | Material | | Weight % |
|---|---|---|---|
| Oil Modified Polyurethane | Spenkel F47-M-60 | 50.10 | Film Forming Binder |
| Dispersant | Nuosperes 657 | 0.46 | Additives |
| Thixatrope | Bentone SD-1 | 0.95 | Thixotrope |
| Solvent | Mineral Spirits | 6.18 | Volatile Component |
| Prime Pigment | Tronox CR-828 | 23.90 | Color Producing Comp |
| Cobalt Drier | 12% Cobalt Naphthenate | 0.38 | Additives |
| Calcium Drier | 6% Calcium Naphthenate | 1.26 | Additives |
| Zirconium Drier | 24% Zirconium Naphthanete | 1.61 | Additives |
| Anti-Skin Agent | Exkin #2 | 0.11 | Additives |
| Blowing Agent | Melamine | 5.25 | Fire Retardant Component |
| Catalyst | Melamine Polyphosphate | 4.50 | Fire Retardant Component |
| Carbonific | Pentaerytritol | 5.25 | Fire Retardant Component |
| | | 100.00 | |

### EXAMPLE 4

Strippable Vinyl Coating

| Function | Material | Weight % | |
|---|---|---|---|
| Vinyl Resin High M.W. | Ucar YVNS | 7.38 | Film Forming Binder |
| Vinyl Resin Low M.W. | Ucar VYHD | 3.69 | Film Forming Binder |
| Plasticizer | Dioctyl Phthalate | 2.88 | Film Forming Binder |
| White Pigment | TiPure 902 | 6.50 | Color Producing Component |
| Diluent | Toluene | 22.20 | Volatile Component |
| Ketone Solvent | Methyl Isobutyl Ketone | 20.95 | Volatile Component |
| Acetate Solvent | Butyl Acetate | 21.40 | Volatile Component |
| Blowing Agent | Melamine | 5.25 | Fire Retardant Component |
| Catalyst | Melamine Polyphosphate | 4.50 | Fire Retardant Component |
| Carbonific | Pentaerythritol | 5.25 | Fire Retardant Component |
| | | 100.00 | |

### EXAMPLE 5

Nitrocellulose Satin Lacquer

| Function | Material | Weight % | |
|---|---|---|---|
| Low MW Nitrocellulose | Nitrocellulose ¼ sec | 6.75 | Film Forming Binder |
| High MW Nitrocellulose | Nitrocellulose ½ sec | 0.10 | Film Forming Binder |
| Diluent | Toluene | 13.75 | Volatile Component |
| Lateral Solvent | Isopropanol | 2.70 | Volatile Component |
| Fast Solvent | Butyl Acetate | 27.60 | Volatile Component |
| Slow Solvent | PM Acetate | 2.70 | Volatile Component |
| Coconut Alkyd 70% in BA | Bookosol 91-470 | 12.78 | Film Forming Binder |
| Plasticizer | Dioctyl Phthalate | 1.34 | Film Forming Binder |
| White Pigment | TiPure 902 | 9.80 | Color Producing Comp |
| Crosslinker | Cymel 303 | 6.95 | Film Forming Binder |
| Crosslinker Catalyst | Butyl Acid Phosphate | 0.53 | Additives |
| Blowing Agent | Melamine | 5.25 | Fire Retardant Component |
| Catalyst | Melamine Polyphosphate | 4.50 | Fire Retardant Component |
| Carbonific | Pentaerythritol | 5.25 | Fire Retardant Component |
| | | 100.00 | |

### EXAMPLE 6

Eggshell Latex Paint

| Function | Material | Weight % | |
|---|---|---|---|
| Solvent | Water | 25.3 | Volatile Component |
| Dispersant | Potassium Tripolyphosphate | 0.22 | Additives |
| Surfactant | Igepal CO-630 | 0.84 | Additives |
| Defoamer | Colloid 643 | 0.23 | Additives |
| Wet Edge Control | Propylene Glycol | 2.77 | Additives |
| Biocide | Nuosept 95 | 0.38 | Additives |
| White Pigment | Tipure 902 | 18.14 | Color Producing Comp |
| Blowing Agent | Melamine | 5.25 | Fire Retardant Component |
| Catalyst | Melamine Polyphosphate | 4.5 | Fire Retardant Component |
| Carbonific | Pentaerythritol | 5.25 | Fire Retardant Component |
| Celluolosic Thickener | Bernocol E411 FQ | 0.32 | Thixotrope |
| Latex Polymer 55% | Rovace 9100 | 34.88 | Film Forming Binder |
| pH Adjustment | 28% Ammonia Hydroxide | 0.13 | Additives |
| Associative Thickener | Acrysol RM-5 | 1.82 | Thixotrope |
| | | 100.00 | |

### Method of Preparation

The above samples were prepared by a Cowles High Speed Disperser. Following a normal paint manufacture technique, the powdered materials were dispersed at highspeed into a suitable amount of the vehicle which contained the dispersants and wetting agents. After the dispersion was complete the speed was reduced balance of the vehicle was added together with the remaining ingredients in the formula.

### EXAMPLE 7

Acrylic Powder Coating

| Function | Material | Weight % | |
|---|---|---|---|
| Glycidyl Acrylic Polymer | Fine-Clad A-207-SA | 56.90 | Film Forming Binder |
| Crosslinker | Dodecanedioic Acid | 10.83 | Film Forming Binder |
| Flow Additive | Silwet L-7500 | 0.33 | Additives |
| White Pigment | Titanox 2020 | 16.94 | Color Producing Comp |
| Blowing Agent | Melamine | 5.25 | Fire Retardant Component |
| Catalyst | Melamine Polyphosphate | 4.50 | Fire Retardant Component |
| Carbonific | Pentaerythritol | 5.25 | Fire Retardant Component |
| | | 100.00 | |

Bake Temperature: 20 minutes at 150 C.

### Method of Preparation

Powders were mixed and blended using a W&P ZSK-30 Blender.

Barrel Temperature 60/80 C.

Screw Speed: 250 rpm.

Classification: 100% through 200 mesh.

It will be understood that each of the elements described above, or two or more together, may also find a useful application in other types of substances and methods differing from the types described above.

While the invention has been illustrated and described as embodied in paint, and method of producing the same, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A method of painting a surface in a predetermined color, comprising the steps of providing a paint including a film-forming binder component for forming a film of the paint on the surface, a color-producing component for providing the predetermined color on the surface, and a fire-retardant component adapted to protect the surface from consequences of fire; and painting the surface with said paint so a to impart the predetermined color to the surface and also to protect the surface from fire.

2. A method as defined in claim 1, wherein said providing includes using the fire-retardant component which includes at least one phosphate selected from the group consisting of melamine polyphosphate, ammonium polyphosphate, melamine diphosphate, melamine pyrophosphate, and melamine phosphate.

3. A method as defined in claim 1, wherein said providing includes using the fire-retardant component which includes melamine or its derivative selected from the group consisting of melamine cyanurate, melamine borate, melamine polyphosphate, melamine diphosphate, melamine pyrophosphate and melamine phosphate.

4. A method as defined in claim 1, wherein said providing includes using said fire retardant component which includes a charring agent, a blowing agent and an additional element which includes phosphate or its derivatives or melamine or its derivatives.

5. A method as defined in claim 1, wherein said providing includes using said fire retardant component which does not exceed 15 weight % of the paint.

6. A method as defined in claim 1, wherein said providing includes using said fire-retardant component which includes melamine, pentaerythritol and melamine polyphosphate.

7. A method as defined in claim 6, wherein said providing includes using said fire retardant component which include 5.25% of melamine, 5.25 weight % of pentaerythritol; and 4.50 weight % of melamine polyphosphate of total weight of the paint.

8. A method as defined in claim 1, wherein said providing includes using said paint in which additional components including a filler and an additive are added.

9. A paint for painting a surface in a predetermined color, comprising a film-forming binder component for forming a film of the paint on the surface; a color-producing component for providing the predetermined color on the surface; and a fire-retardant component adapted to protect the surface from consequences of fire, such that when a surface is painted with the paint, the predetermined color is imparted to the surface and the surface is protected from fire.

10. A paint as defined in claim 9, wherein said fire-retardant component includes at least one phosphate selected from the group consisting of melamine polyphosphate, ammonium polyphosphate, melamine diphosphate, melamine pyrophosphate, and melamine phosphate.

11. A paint as defined in claim 9, wherein said fire-retardant component includes melamine or its derivative selected from the group consisting of melamine cyanurate, melamine borate, melamine polyphosphate, melamine diphosphate, melamine pyrophosphate and melamine phosphate.

12. A paint as defined in claim 9, wherein said fire retardant component includes a charring agent, a blowing agent and an additional element which includes said phosphate or its derivatives or said melamine or its derivatives.

13. A paint as defined in claim 9, wherein said fire retardant component does not exceed 15 weight % of the paint.

14. A paint as defined in claim 9, wherein said fire retardant component includes melamine, pentaerythritol, and melamine polyphosphate.

15. A paint as defined in claim 14, wherein said-fire retardant component include 5.25 weight % of melamine, 5.25 weight % of pentaerythritol, and 4.50 weight % of melamine polyphosphate of total weight of the paint.

16. A paint as defined in claim 9; and further comprising a filler and an additive.

17. A paint as defined in claim 9, wherein the paint includes the following components:
Example 1
Epoxy Paint-Two Components

| | | |
|---|---|---|
| Function | Material | Weight % |

Part A

| | | | |
|---|---|---|---|
| Liquid Epoxy Resin | Epotuf 37-127 | 32.80 | Film Forming Binder |
| Diluent | Benzyl Alcohol | 3.75 | Film Forming Binder |
| Dispersant | BYK P-104S | 0.32 | Additives |
| Anti-Crater Additive | BYK A-530 | 0.15 | Additives |
| Flow Additive | BYK 501 | 0.16 | Additives |
| Prime Pigment | Titanox 2020 | 12.3 | Color Producing Component |
| Extender | Microna 7 | 18.99 | Dry Powder Component |
| Blowing Agent | Melamine | 5.25 | Fire Retardant Component |
| Catalyst | Melamine Polyphosphate | 4.50 | Fire Retardant Component |
| Carbonific | Pentaerythritol | 5.25 | Fire Retardant Component |

Part B

| | | | |
|---|---|---|---|
| Polyamine Hardener | Epotuf 37-801 | 13.32 | Film Forming Binder |
| Diluent | Benzyl Alcohol | 3.21 | Film Forming Binder |
| | | 100.00 | |

Mix Part A/Part B 4/1 by volume

18. A paint as defined in claim 9, wherein the paint includes the following components:
Example 2
Alkyd Undercoat

| Function | Material | Weight % | |
|---|---|---|---|
| Medium Oil Aklyd 80% | Beckosol AA-203 | 31.48 | Film Forming Binder |
| Solvent | Mineral Spirits | 21.94 | Volatile Component |
| Dispersant | Soya Lecithin | 0.13 | Additives |
| Thixotrops | Thixatrol ST | 0.32 | Thixotrope |
| Sag Control | Post 4 | 0.44 | Thixotrope |
| Cobalt Drier | 12% Cobalt Naphthenate | 0.08 | Additives |
| Calcium Drier | 6% Calcium Naphtenate | 0.78 | Additives |
| Anti-Skin Agent | Methyl Ethyl Ketoxine | 0.33 | Additives |
| Prime Pigment | Tipure 902 | 21.38 | Color Producing Comp |
| Extender Pigment | Nicron 604 | 8.12 | Dry Powder Component |
| Blowing Agent | Melamine | 5.25 | Fire Retardant Component |
| Catalyst | Melamine Polyphosphate | 4.50 | Fire Retardant Component |
| Carbonific | Pentaerythritol | 5.25 | Fire Retardant Component |
| | | 100.00 | |

19. A paint as defined in claim 9, wherein the paint includes the following components:
Example 3
Urethane Enamel

| Function | Material | Weight % | |
|---|---|---|---|
| Oil Modified Polyurethane | Spenkel F47-M-60 | 50.10 | Film Forming Binder |
| Dispersant | Nuosperes 657 | 0.46 | Additives |
| Thixatrope | Bentone SD-1 | 0.95 | Thixotrope |
| Solvent | Mineral Spirits | 6.18 | Volatile Component |
| Prime Pigment | Tronox CR-828 | 23.95 | Color Producing Comp |
| Cobalt Drier | 12% Cobalt Naphthenate | 0.38 | Additives |
| Calcium Drier | 6% Calcium Naphthenate | 1.26 | Additives |
| Zirconium Drier | 24% Zirconium Naphthanete | 1.61 | Additives |
| Anti-Skin Agent | Exkin #2 | 0.11 | Additives |
| Blowing Agent | Melamine | 5.25 | Fire Retardant Component |
| Catalyst | Melamine Polyphosphate | 4.50 | Fire Retardant Component |
| Carbonific | Pentaerytritol | 5.25 | Fire Retardant Component |
| | | 100.00 | |

20. A paint as defined in claim 9, wherein the paint includes the following components:
Example 4
Strippable Vinyl Coating

| Function | Material | Weight % | |
|---|---|---|---|
| Vinyl Resin | Ucar YVNS | 7.38 | Film Forming Binder |
| High M.W. | | | |
| Vinyl Resin | Ucar VYHD | 3.69 | Film Forming Binder |
| Low M.W. | | | |
| Plasticizer | Dioctyl Phthalate | 2.88 | Film Forming Binder |
| White Pigment | TiPure 902 | 6.50 | Color Producing |
| | | | Component |
| Diluent | Toluene | 22.20 | Volatile Component |
| Ketone Solvent | Methyl Isobutyl | 20.95 | Volatile Component |
| | Ketone | | |
| Acetate Solvent | Butyl Acetate | 21.40 | Volatile Component |
| Blowing Agent | Melamine | 5.25 | Fire Retardant Component |
| Catalyst | Melamine | 4.50 | Fire Retardant Component |
| | Polyphosphate | | |
| Carbonific | Pentaerythritol | 5.25 | Fire Retardant Component |
| | | 100.00 | |

21. A paint as defined in claim 9, wherein the paint includes the following components:
Example 5
Nitrocellulose Satin Lacquer

| Function | Material | Weight % | |
|---|---|---|---|
| Low MW | Nitrocellulose | 6.75 | Film Forming Binder |
| Nitrocellulose | ¼ sec | | |
| High MW | Nitrocellulose | 0.10 | Film Forming Binder |
| Nitrocellulose | ½ sec | | |
| Diluent | Toluene | 13.75 | Volatile Component |
| Lateral Solvent | Isopropanol | 2.70 | Volatile Component |
| Fast Solvent | Butyl Acetate | 27.60 | Volatile Component |
| Slow Solvent | PM Acetate | 2.70 | Volatile Component |
| Coconut Alkyd | Bookosol 91-470 | 12.78 | Film Forming Binder |
| 70% in BA | | | |
| Plasticizer | Dioctyl Phthalate | 1.34 | Film Forming Binder |
| White Pigment | TiPure 902 | 9.80 | Color Producing Comp |
| Crosslinker | Cymel 303 | 6.95 | Film Forming Binder |
| Crosslinker | Butyl Acid | 0.53 | Additives |
| Catalyst | Phosphate | | |
| Blowing Agent | Melamine | 5.25 | Fire Retardant Component |
| Catalyst | Melamine | 4.50 | Fire Retardant Component |
| | Polyphosphate | | |
| Carbonific | Pentaerythritol | 5.25 | Fire Retardant Component |
| | | 100.00 | |

22. A paint as defined in claim 9, wherein the paint includes the following components:
Example 6
Eggshell Latex Paint

| Function | Material | Weight % | |
|---|---|---|---|
| Solvent | Water | 25.3 | Volatile Component |
| Dispersant | Potassium | 0.22 | Additives |
| | Tripolyphosphate | | |
| Surfactant | Igepal CO-630 | 0.84 | Additives |
| Defoamer | Colloid 643 | 0.23 | Additives |
| Wet Edge | Propylene Glycol | 2.77 | Additives |
| Control | | | |
| Biocide | Nuosept 95 | 0.38 | Additives |
| White Pigment | Tipure 902 | 18.11 | Color Producing Comp |
| Blowing Agent | Melamine | 5.25 | Fire Retardant Component |
| Catalyst | Melamine | 4.5 | Fire Retardant Component |
| | Polyphosphate | | |
| Carbonific | Pentaerythritol | 5.25 | Fire Retardant Component |
| Celluolosic | Bernocol E411 | 0.32 | Thixotrope |
| Thickener | FQ | | |
| Latex Polymer | Rovace 9100 | 34.88 | Film Forming Binder |
| 55% | | | |
| pH Adjustment | 28% Ammonia | 0.13 | Additives |
| | Hydroxide | | |
| Associative | Acrysol RM-5 | 1.82 | Thixotrope |
| Thickener | | 100.00 | |

Method of Preparation
The above samples were prepared by a Cowles High Speed Disperser. Following a normal paint manufacture technique, the powdered materials were dispersed at highspeed into a suitable amount of the vehicle which contained the dispersants and wetting agents. After the dispersion was complete the speed was reduced balance of the vehicle was added together with the remaining ingredients in the formula.

23. A paint as defined in claim 9, wherein the paint includes the following components:
Example 7
Acrylic Powder Coating

| Function | Material | Weight % | |
|---|---|---|---|
| Glycidyl | Fine-Clad | 56.90 | Film Forming Binder |
| Acrylic | A-207-SA | | |
| Polymer | | | |
| Crosslinker | Dodecanedioic | 10.83 | Film Forming Binder |
| | Acid | | |
| Flow Additive | Silwet L-7500 | 0.33 | Additives |
| White Pigment | Titanox 2020 | 16.94 | Color Producing Comp |
| Blowing Agent | Melamine | 5.25 | Fire Retardant Component |
| Catalyst | Melamine | 4.50 | Fire Retardant Component |
| | Polyphosphate | | |
| Carbonific | Pentaerythritol | 5.25 | Fire Retardant Component |
| | | 100.00 | |

Bake Temperature: 20 minutes at 150 C.
Method of Preparation
Powders were mixed and blended using a W&P ZSK-30 Blender.
Barrel Temperature 60/80 C.
Screw Speed: 250 rpm.
Classification: 100% through 200 mesh.

24. A method of producing a paint for painting a surface in a predetermined color, comprising the steps of mixing a film-forming binder component for forming a film of the paint on the surface, and a color-producing component for providing the predetermined color on the surface; and adding a fire-retardant component adapted to protect the surface from consequences of fire, so that when a surface is painted with the thusly produced paint, the predetermined color is imparted to the surface and the surface is protected from fire.

25. A method as defined in claim 24, wherein said adding includes using the fire-retardant component which includes at least one phosphate selected from the group consisting of melamine polyphosphate, ammonium polyphosphate, melamine diphosphate, melamine pyrophosphate, and melamine phosphate.

26. A method as defined in claim 24, wherein said adding includes using the fire-retardant component which includes melamine or its derivatives selected from the group consisting of melamine cyanurate, melamine borate, melamine polyphosphate, melamine diphsophate, melamine pyrophosphate and melamine phosphate.

27. A method as defined in claim 24, wherein said adding includes using said fire retardant component which includes a charring agent, a blowing agent and an additional element which includes said phosphate or its derivatives or said melamine or its derivatives.

28. A method as defined in claim 24, wherein said adding includes using said fire retardant component which does not exceed 15 weight % of the paint.

29. A method as defined in claim 24, wherein adding includes using said fire retardant component which includes melamine, pentaerythritol, and melamine polyphosphate.

30. A method as defined in claim 29, wherein adding includes using said fire retardant component which include 5.25 weight % of melamine, 5.25 weight % of pentaerythritol, and 4.50 weight % of melamine polyphosphate of total weight of the paint.

31. A method as defined in claim 24; and further comprising introducing into the paint a filler and an additive.
